(19) United States
(12) Patent Application Publication
(10) Pub. No.: US 2007/0154860 A1
(43) Pub. Date: Jul. 5, 2007

(54) Dental matrix

(76) Inventor: Arthur P. Kerle, Grayling, MI (US)

Correspondence Address: Douglas S. Bishop;Bishop & Heintz, P.C., P.O. Box 707, Traverse City, MI, 49685-0707, US

(21) Appl. No.: 11/498,435

(22) Filed: Aug. 3, 2006

Related U.S. Application Data
(60) Provisional application No. 60/755,735, filed on Dec. 30, 2005.

(51) Int. Cl. A61C 5/04

(52) U.S. Cl. 433/39

(57) ABSTRACT

A dental matrix, for use in filling interproximal tooth surfaces. The matrix, in its main body, or base, is constructed of known matrix materials, such as metal, or stiff translucent or transparent polyester material such as Mylar®. One or more open areas in the main body of the matrix are provided, with those open areas covered by a film material, which may expand, without elastic memory, to provide separation of the exterior portion of the filling from the interproximal surface of an adjacent tooth. The film may be a fluorocarbon material. The utilization of a transparent or translucent base matrix material allows light curing of the filling material. The matrix main body or base may be in any standard shape, for utilization, singly, as held in place by a wedge, in conjunction with a Tofflemire retainer, or other retaining device.

### BACKGROUND OF THE INVENTION

The instant invention is generally related to the dentistry field and specifically related to matrix-type devices utilized in conjunction with fillings in the interproximal areas between adjacent teeth. Utilization of matrices or matrix-type devices for such fillings is generally known. U.S. Pat. No. 5,327,22 dated Jan. 15, 1895, to Dennis, for a dental matrix, discloses a dental matrix comprised of two plates adapted to embrace the edges of opposing teeth, among other things; U.S. Pat. No. 5,035,615, to Din, for a dental filling band and method of use, discloses a flexible dental matrix band which is bondable to resin-based restorative materials; U.S. Pat. No. 4,704,085, to Dragen, for a retainerless matrix band, discloses a dental matrix band which is preformed or contoured and may be held in place without a retaining tool; U.S. Pat. No. 5,788,487, to Meyer, discloses a dental shim which is insertable between two adjacent teeth; U.S. Pat. No. 5,380,198, to Suhonen, for a matrix for dental medicine and device for the fabrication of matrix bands, discloses a dental matrix with at least one transparent region for utilization in light-cured composite restorations; U.S. Patent Application Publication No. US2003/0186186A1, for Hahn, published Oct. 2, 2003, for an interproximal matrix with elastomeric wedge, discloses a double matrix having a resilient wedge member attached to it; U.S. Patent Application Publication No. US2002/0172920A1, for Bills, published Nov. 21, 2002, for anatomically contoured matrix bands for use in dental restoration procedures, discloses a matrix band having an asymmetrical shape to provide form for molding a dental filling into a shape that closely approximates the asymmetrical and generally trapezoidal shape of a tooth; U.S. Pat. No. 6,712,608B2, to Bills, for anatomically contoured matrix bands for use in dental restoration procedures, issued from that published application.

The prior art, however, does not provide for a dental matrix which provides a separation surface between interproximal areas of adjacent teeth without material “memory”. That is, prior art applications, including those referenced above, have, in general, provided either a rigid matrix material, or a matrix material, if pliable or expandable, which contains at least some elasticity, or “memory” characteristic, tending to return it to its initial position. Likewise, although applications of the prior art include a transparent “window” in a matrix, the prior art does not provide a dental matrix made entirely of light-transmitting material, which may be transparent or translucent, nor does it provide a window or entire matrix of light-transmitting material without a “memory” material function.

Thus, as is clear from the prior art, a definitive need exists for a dental matrix, which provides essential base rigidity to allow proper positioning between adjacent teeth, with a non-memory material function, to maintain separation from a filling placed in the interproximal area of a tooth and the adjacent tooth, providing the separation material does not have a significant “memory” component and, if desired, in particular for anterior tooth applications, providing a light-transmitting function in both the separation film material and in the general material of the matrix body itself.

The present invention is directed to a dental matrix device which addresses the cited shortcomings in the prior art.

### SUMMARY OF THE INVENTION

The current dental matrix invention may be summarized in two primary embodiments. Both embodiments solve the problem of open contacts when placing direct composite restorations.

In one embodiment, the device is kidney bean shaped piece of metal and an expandable, non-elastic, membrane, which in practice may be a fluorocarbon film or PTFE, commonly known under the trademark name of “Teflon®”. The device however, is not dependant upon a particular shape and may be in other shapes, including rectangular. The general shape requirement need only provide for a sufficient length dimension to be able to be placed between interproximal surfaces of adjacent teeth, with sufficient base material on either end, to hold in place the fluorocarbon film material. Likewise, the device need only have a height dimension sufficient to provide a supported open area sufficient to maintain the fluorocarbon film separation of an area at least equal to the size of the filling, and between the filling to be installed, and the adjacent interproximal tooth surface. In the demonstrated embodiment, the device is preferably approximately 17 mm long by 7 mm high, but the invention is not limited to particular dimensions. The device is configured to fit between the tooth being restored and the proximal tooth. The fluorocarbon film window may be lightly burnished to fit the proximal tooth's surface. After an interproximal wedge has been placed and the restoration has been placed, the matrix is removed with a hemostat or cotton pliers. The “residue” of the fluorocarbon film tape may be removed with floss when testing the proximal contact. The base matrix material needs to be stiff, but flexible, and have the ability to hold shape, either independently, or by wedges, or other retainers, when it is bent to fit the circumference of the tooth being worked upon. The fluorocarbon film is adhered to the base matrix member with an adhesive, which may be cyanoacrylate.

A second embodiment of the instant invention, which may have the same approximate dimensions of the above described matrix, and which may be in any of the above referenced shapes, subject only to the limitations mentioned above, differs in material, as a stiff, translucent or transparent polyester film such as Mylar® may be used as the primary material of the base matrix. The advantage of using this material over metal, or any other non-light transmitting material, is twofold: (1) The restoration may be light-cured through the matrix for complete curing; and (2) The plastic or Mylar may be color-coded to match different tooth or restorative widths or depths. These and other embodiments and advantages of the device may be seen in the written description and drawings attached.

In either of the above embodiments, the matrix may be conformed to act singly, in providing a barrier between interproximal tooth surfaces, or may be held in place by wedges, or other dental retainer means.

The device may also be used with a standard Tofflemire matrix band and retainer that is used commonly in many dental offices. (The retainer is the device which holds the matrix around the tooth.) The band or matrix may be modified with Teflon® fluorocarbon film windows, or indentations, or other non-elastic translucent film material, and used for placing fillings. The Tofflemire matrix, as shown in the attached drawings, may be used instead of a sectional matrix, when the practitioner is more accustomed to using the Tofflemire system. There are also some instances in which a Tofflemire matrix may fit the circumstance better than a sectional matrix (there may be circumstances where a cavity, and a filling to be interposed lie not just between the adjacent interproximal tooth, but continues into the cheek-side or the tongue-side of the tooth, and which case a sectional matrix might not be able to form that side of the restoration). Conversely, when the restoration is purely within the interproximal region, there may be significant time and convenience advantages to using merely a single sectional matrix, without having to utilize a more bulky Tofflemire retainer.

In any of the above embodiments of the invention, the non-elastic, translucent or transparent film material, is adhered to either the sectional matrix or the Tofflemire matrix band, in a manner which allows the film to cover an open area on the band surface. In practice, this open area may be defined by an indentation along the upper surface of the matrix, or band, or by an aperture defined by the band's surface. This open area may be in differing shapes particularly adapted for anterior or posterior tooth applications.

The above and additional features of the invention may be considered, and will become apparent in conjunction with the drawings, in particular, in the detail description which follow:

### BRIEF DESCRIPTION OF THE DRAWINGS

The following detailed description is best understood by reference to the following drawings:

FIG. 1 is a side view of the invention showing an open area in the base matrix member covered by fluorocarbon film.

FIG. 2 is a side view of the invention in which two open areas are shown, both defined by indentations from the upper surface edge, and covered by fluorocarbon film. The open areas is defined in FIG. 2 are narrower, for utilization on anterior teeth.

FIG. 2A is a side view of the invention showing two open areas formed by indentation from the upper surface edge of the base member covered by fluorocarbon film. The indentations are wider for utilization on both interproximal surfaces of a posterior tooth.

FIG. 3 shows a base member, with one narrower open area, covered by fluorocarbon film for utilization on one interproximal surface of an anterior tooth.

FIG. 4 is a perspective view of the matrix device, with the fluorocarbon film open area, inserted between an upper anterior tooth with a cavity, and the interproximal surface of the adjacent tooth.

FIG. 5 is a perspective view of the device, again, in place between an upper anterior tooth having a cavity, and the interproximal surface of the adjacent tooth, with the device held in place with a wedge, and bent around the anterior tooth having the cavity, so that even portions of the filling area not normally contacting the interproximal surface of the adjacent tooth are covered by the device.

FIG. 6 is a perspective view of the device, with a wedge holding it in place, wherein the cavity of the upper anterior tooth has been filled, with the fluorocarbon film separating the cavity from the interproximal surface of the adjacent tooth.

FIG. 7 is a perspective view of anterior teeth, with filling completed, and matrix device removed.

FIG. 8 is a side perspective view of the device, in kidney bean shape, with the device constructed of metal, with fluorocarbon film covering the open area created by an indentation in the upper surface of the base member.

FIG. 9 is a perspective side view of a metal matrix of the prior art, commonly in use.

FIG. 10 is a side perspective view of two posterior teeth, with the filling on the interproximal surface of one, and a metal matrix device in place, held in with a wedge, maintaining the fluorocarbon film between the area of the cavity, and the interproximal surface of the adjacent posterior tooth.

FIG. 11 is an overhead view of two adjacent anterior teeth with the filling on the interproximal surface of one, and a metal matrix device in place, held in with a wedge, maintaining the fluorocarbon film between the area of the cavity, and the interproximal surface of the adjacent posterior tooth.

FIG. 12 is a top view of three adjacent posterior teeth with the middle tooth having cavities on each interproximal surface, with a matrix device, held in place with a wedge between each cavity and the interproximal surface of each adjacent tooth.

FIG. 13 is a top view of three adjacent posterior teeth, with the middle tooth having cavities on each interproximal surface, with a Tofflemire matrix band having two open areas covered by fluorocarbon film, held in place by the Tofflemire retainer.

FIG. 14 is a side view of a metal sectional matrix with the open area defined by an opening in the matrix surface itself.

### DETAILED DESCRIPTION

Throughout the following detailed description, like numerals to describe the same element of the present invention are shown in multiple figures thereof.

The invention, Dental Matrix, is a novel improvement of a device for use in filling interproximal tooth surfaces. The device and method set forth herein allow a dental practitioner a convenient and practical solution to the problem of providing appropriate minimal separation of the exterior portion of a filling from the interproximal area of an adjacent tooth.

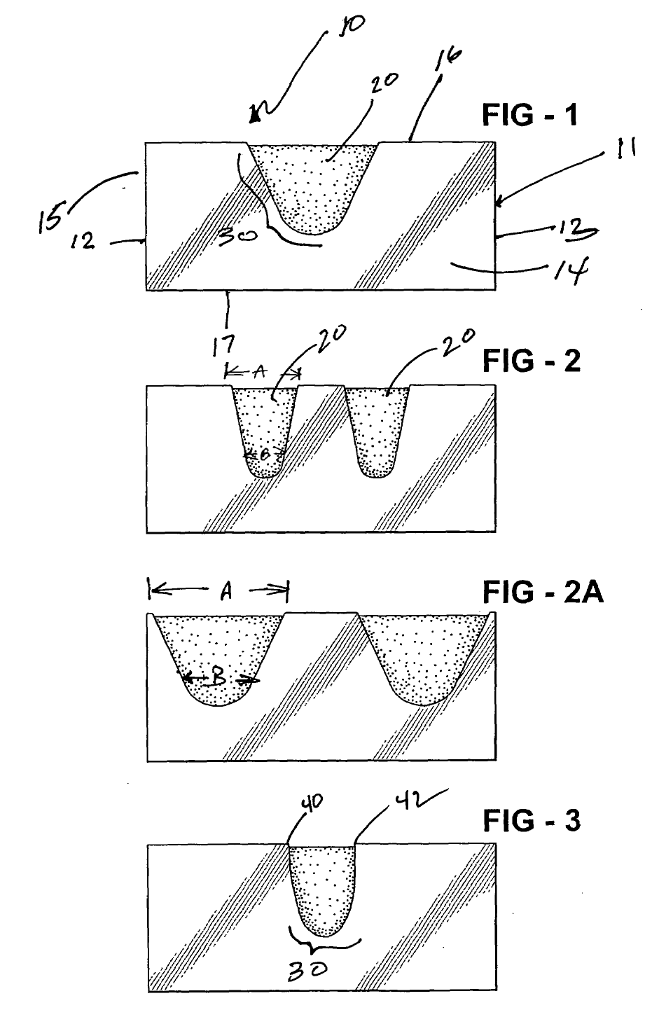

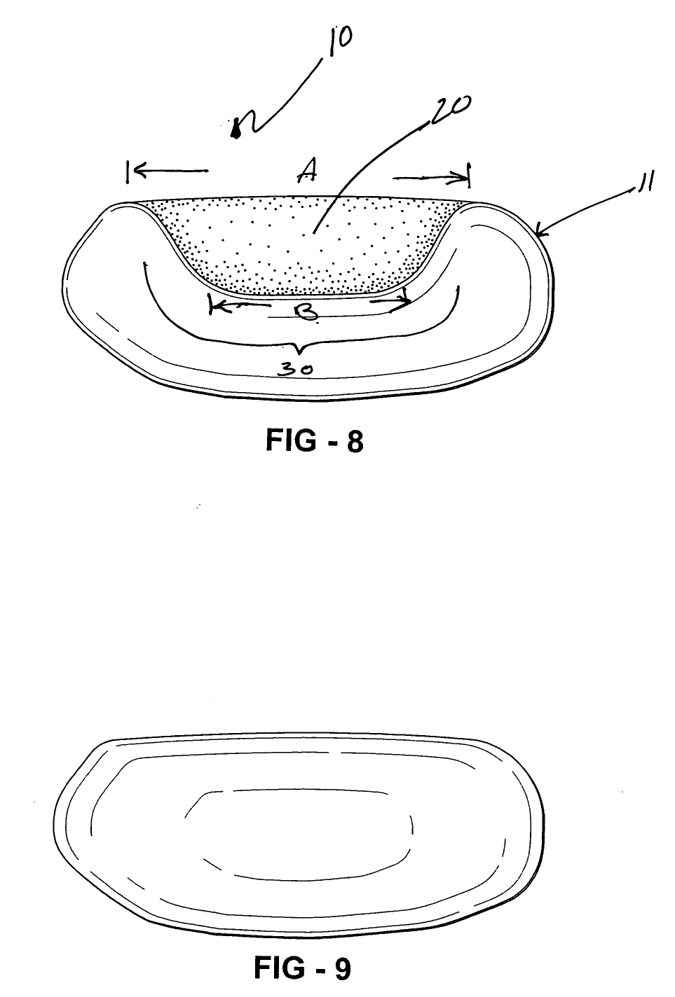

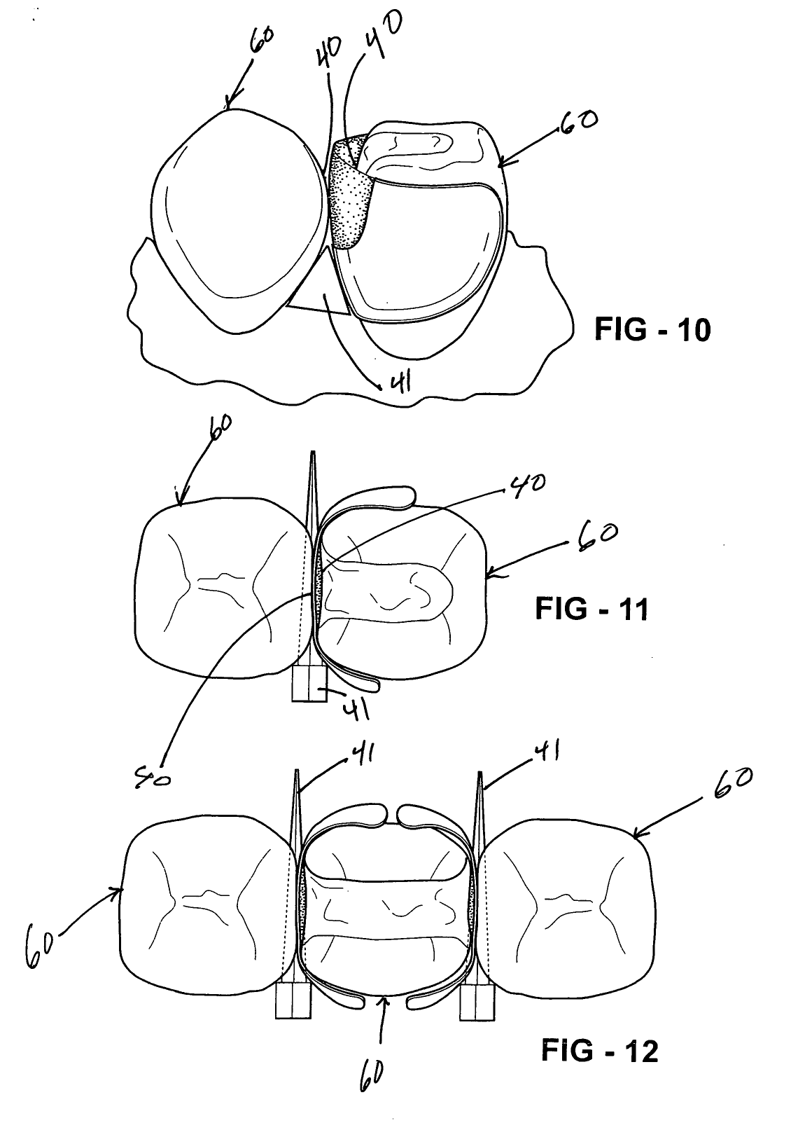

Broadly considered, the device, Dental Matrix 10 is comprised of a primary sheet member 11 of bendably stiff material. Said primary sheet member 11 may be comprised of metal or synthetic material such as Mylar® plastic or other translucent material. Sheet member 11 is generally oblong and may be rectangular, as shown in FIGS. 1-6, or of a substantially oval, “kidney” shape, as shown in FIGS. 8-12, and 14.

Member 11 has a first end 12 and a second end 13, a first surface 14, which is usually substantially planar, and corresponding second surface 15, which is likewise substantially planar. An upper edge 16 and lower edge 17 further define the first surface 14 and second surface 15.

At least a portion of the primary member 11 is covered by a membrane 20. Membrane 20 is comprised of a permanently deformable material so that it is substantially without “elastic” memory. Then, when membrane 20 is deformed or expanded, it retains its deformed or expanded shape, which is a primary benefit of the Dental Matrix 10. In practice, membrane 20 may be formed from a fluorocarbon film material such as Teflon® tape. Although the invention is not limited to a particular thickness of membrane 20, optimum results are obtained utilizing a membrane 20 having a thickness within a range of 0.001 to 0.005 inches with a preferred thickness range therein of 0.002 to 0.003 inches.

The primary member 11 also provides one or more open areas 30 defined by the first surface 14 and the second surface 15, either entirely, as shown in FIG. 14, or in cooperation with upper edge 16 as shown in FIGS. 1-6 and 8-13, to form a valley extending from a first point 40 on upper edge 16, downwardly toward a lower point 41, then upwardly to a second point 42 on upper edge 16, so as to provide an upper relatively wide dimension A and a lower relatively narrow dimension B.

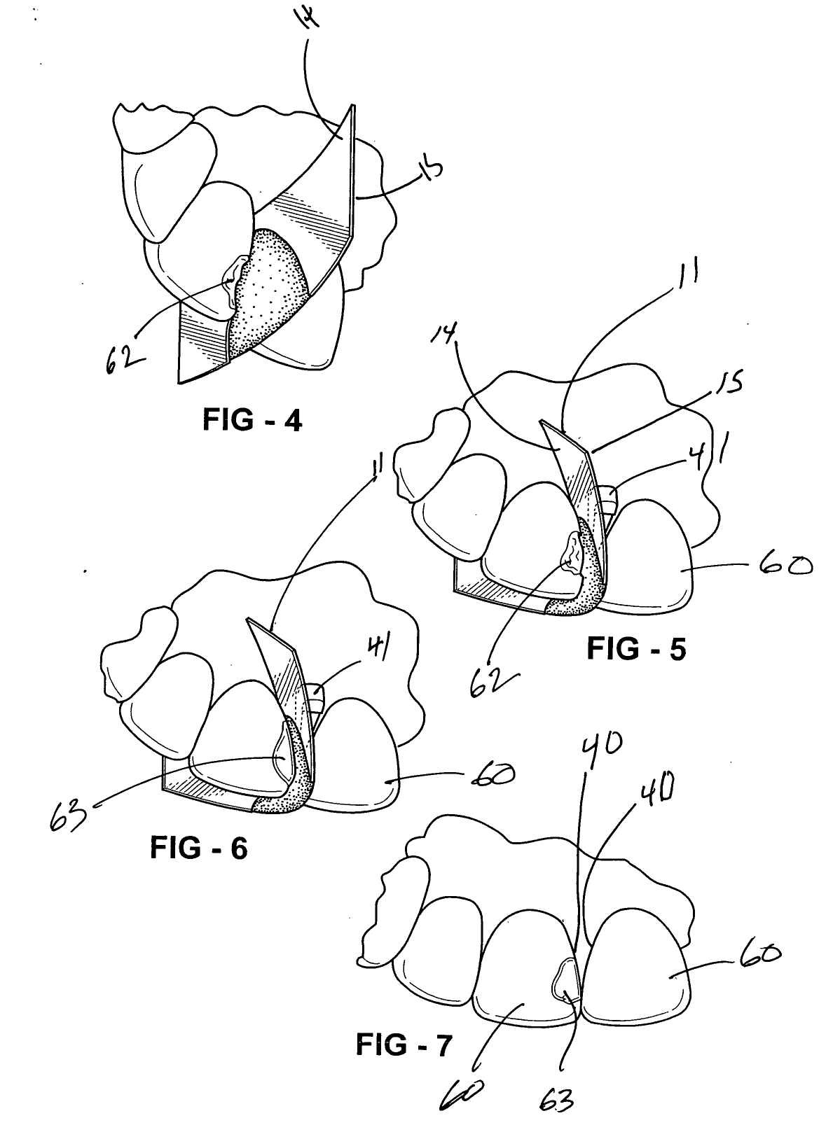

While a specific shape of each open area 30 is not required, in practice, providing for open areas 30, in a “U” shape as demonstrated in FIGS. 1 and 2A with a wider dimension A relative to dimension B is a more practical shape for utilization with posterior tooth applications, while open areas 30 in a rounded “V” shape, as shown in FIGS. 1 and 3, providing less relative difference between dimension A and dimension B, may be more practical for anterior tooth applications.

It is generally considered optimum to have a wider open area 30 proximate the upper edge 16 to allow maximum access to the dental practitioner.

The device 10 presents a generally linear and continuous upper edge 16, running between first end 12 and second end 13, embodied by upper edge 16 of primary member 11 with continuity over any open area 30, or valley, in cooperation with membrane 20. Membrane 20 is affixed to primary member 11 by an adhesive, or other means sufficient to form a permanent bond.

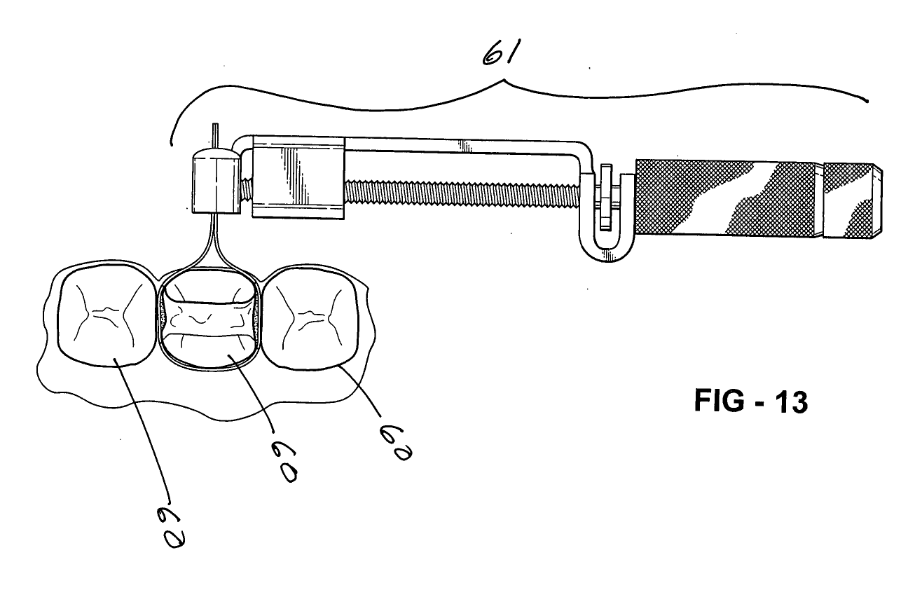

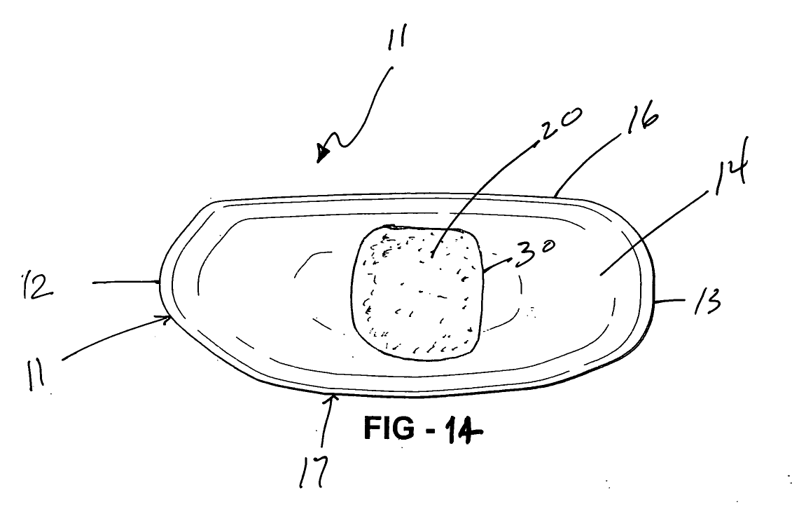

The device 10, by virtue of the shape and material composition of primary member 11, may be adaptable for use in filling cavities on interproximal tooth surfaces 40 either by holding itself in place by being comprised of a permanently bendable metal material; a wedge as shown in FIGS. 10-12, or with a Tofflemire retainer tool 61, as shown in FIG. 13.

In practice, a dental practitioner utilizes the device 10 by selecting an appropriately configured device 10 for the particular tooth 60 and interproximal surface 40 thereof, giving consideration to the size, number and location(s) of the particular cavity 62 or cavities 62 to be filled.

The device 10 is inserted between the tooth 60 having an interproximal area 40 cavity 62 and the tooth 60 adjacent to said interproximal area 40 cavity 62. The device 10 is adjusted and positioned so that the interproximal area 40 cavity 62 to be filled is centered within an open area 30 or valley of the primary sheet member 11 with the cavity 62 shielded from the interproximal area 40 of the adjacent tooth 60 by the membrane 20 covering area 30, as shown in FIGS. 4 and 5.

The device 10 is then held in place by a restraining means, which, as indicated above, may be from bendably deforming the device itself; by providing a wedge 41 driven between the primary member 11 and the adjacent tooth 60 as shown in FIGS. 5 and 6, and 10-12; or utilization of a Tofflemire retainer 61, with entire matrix device 10 encircling the tooth 60 to be filled, under tension, as shown in FIG. 13.

The dental practitioner then fills the cavity 62 leaving a permanent filling 63 in the interproximal area 40 of the tooth 60, as shown in FIG. 6.

The device 10 is then removed from between the adjacent teeth 60, leaving the filling 63, as shown in FIG. 7.

In utilization of the device 10, particularly for anterior tooth application, it may be desirable for both film 20 and primary member 11 to be comprised of translucent material, such as the aforementioned Mylar®, to allow light penetration and appropriate colorization in the curing of the filling 63.

As shown in the FIG. 2, 2A and 18, one matrix device 10 may have a primary member 11 with multiple open areas 30 to allow one device 10 to be used when filling a cavity 62 on opposite interproximal areas 40 of a single tooth 60.

It is the claims appended hereto, and all reasonable equivalents thereof, which define the true scope of the invention and the invention is not limited to the depicted embodiments and exemplifications.

What is claimed is:

1. A dental matrix device for use in filling dental cavities in interproximal surface areas between adjacent teeth, comprising:
a primary bendably stiff sheet member having a first end and a second end and first surface and a corresponding second surface;
said first and second surfaces being defined by an upper edge and a lower edge;
said first and second surfaces, further defining one or more open valley areas in cooperation with said upper edge; and
a membrane of a permanently deformable material extending across a portion of a surface of said sheet member;
each open valley area of said primary sheet member covered by said membrane.

2. The device of claim 1, wherein the primary sheet member is comprised of metal.

3. The device of claim 1, wherein the primary sheet member is comprised of translucent material.

4. The device of claim 1, wherein the permanently expandable member is comprised of a fluorocarbon film material.

5. The device of claim 1, wherein each open valley area has an upper relative wide dimension and a lower relative narrow dimension.

6. The device of claim 5, wherein each open valley area is substantially a rounded “V” shape.

7. The device of claim 5, wherein each open valley area is substantially “U” shaped.

8. The device of claim 1, wherein the first surface and the corresponding second surface of the primary sheet member are each substantially planar.

9. The device of claim 1, wherein the upper edge and the membrane covering each open valley area comprise a substantially consistent upper boundary of the device.

10. The device of claim 1, wherein the device is adaptable for use with a Tofflemire retainer.

11. The device of claim 1, wherein the device is a sectional matrix in substantially oval shape, indented on one side.

12. The device of claim 1, wherein the device is a sectional matrix in substantially rectangular shape.

13. The device of claim 4, wherein the fluorocarbon film material has a thickness within a range of 0.001 to 0.005 inches.

14. A dental matrix device for use in filling dental cavities in interproximal surface areas between adjacent teeth, comprising:
a primary bendably stiff sheet member having a first end and a second end and first surface and a corresponding second surface;
said first and second surfaces being defined by an upper edge and a lower edge;
said first and second surfaces, further defining one or more apertures; and
a membrane of a permanently deformable material extending across a portion of a surface of said sheet member;
each aperture of said primary sheet member covered by said membrane.

15. The device of claim 14, wherein the primary sheet member is comprised of metal.

16. The device of claim 14, wherein the primary sheet member is comprised of translucent material.

17. The device of claim 14, wherein the permanently expandable member is comprised of a fluorocarbon film material.

18. The device of claim 14, wherein the first surface and the corresponding second surface of the primary sheet member are each substantially planar.

19. The device of claim 14, wherein the device is adaptable for use with a Tofflemire retainer.

20. A method for protecting the adjacent interproximal surface area of or more adjacent teeth, when filling a dental cavity in the interproximal surface area of the primary tooth, comprising the following steps:
A. Providing a dental matrix comprising:
A dental matrix device for use in filling dental cavities in interproximal surface areas between adjacent teeth, comprising:
a primary bendably stiff sheet member having a first end and a second end and first surface and a corresponding second surface;
said first and second surfaces being defined by an upper edge and a lower edge;
said first and second surfaces, further defining one or more open valley areas in cooperation with said upper edge; and
a membrane of a permanently deformable material extending across a portion of a surface of said sheet member;
each open valley area of said primary sheet member covered by said membrane.
B. Inserting the matrix of Step A between a tooth having an interproximal area cavity and the adjacent tooth to said cavity.
C. Adjusting the matrix of Step A so that the cavity to be filled is substantially centered within an open valley area of the primary sheet member and the area of the cavity is shielded from the adjacent tooth by the membrane covering the open valley area.
D. Holding the matrix of Step A in place with a restraining means.
E. Filling the cavity in the inteproxial area of the tooh.
F. Removing the matrix of Step A.

21. The method of claim 20, wherein sheet member of the matrix of Step A is comprised of metal.

22. The method of claim 20, wherein the sheet member of Step A is comprised of translucent material.

23. The method of claim 20, wherein the permanent expandable membrane is comprised of a fluorocarbon film material.

24. The method of claim 20, wherein each open valley area has a relative wide upper dimension and a relative narrow lower dimension.

25. The method of claim 24, wherein each open valley area of the matrix of Step A is substantially a rounded “V” shape.

26. The method of claim 24, wherein each open valley area of the matrix of Step A is substantially a rounded “U” shape.

27. The method of claim 20, wherein the upper edge and the membrane covering each open valley area of the matrix of Step A comprise a substantially consistent upper boundary of the device.

28. The method of claim 20, wherein the first surface and the second surface of the primary sheet member of the matrix of Step A are each substantially planar.

29. The method of claim 20, wherein the restraining means of Step D is a Tofflemire retainer.

30. The method of claim 20, wherein the restraining means of Step D is one or more wedge members inserted between the interproximal surfaces of the adjacent teeth.

31. The method of claim 20, wherein the restraining means of Step D is providing a matrix or Step A wherein said matrix is comprised of deformably bendable material.

32. The method of claim 20, wherein the primary tooth has at least one cavity to be filled on each opposite interproximal tooth surface and the matrix provided in Step A is inserted between the adjacent teeth on each side of the tooth having said cavities, each opposite cavity substantially centered within an open valley of the primary sheet member and the area of each cavity is shielded from the respective adjacent tooth by the portion of the membrane covering the corresponding open valley area.

33. The method of claim 23, wherein the fluorocarbon film material has a thickness within a range of 0.001 to 0.005 inches.
